(19) United States
(12) Patent Application Publication
(10) Pub. No.: US 2019/0102234 A1
(43) Pub. Date: Apr. 4, 2019

(54) Executing runtime programmable applications

(71) Applicant: Robotonchip Oy, Espoo (FI)

(72) Inventors: Jari Rahkala, Espoo (FI); Marko Lamminaho, Espoo (FI)

(21) Appl. No.: 16/147,617

(22) Filed: Sep. 29, 2018

(30) Foreign Application Priority Data
Sep. 29, 2017 (FI) 20175867

(51) Int. Cl. G06F 9/54; H04L 29/08

(52) U.S. Cl. CPC G06F 9/54; H04L 67/26

(57) ABSTRACT

According to an example aspect of the present invention, there is provided system comprising a first apparatus configured to execute a first runtime programmable application, and a second apparatus configured to execute a second runtime programmable application, wherein the first runtime programmable application program comprises one or more references to variables of the second apparatus, wherein the first apparatus and the second apparatus are configured to communicate one or more variables defined by the references over a network connection and to set at least one of a variable of the first apparatus and a variable of the second apparatus on the basis of communicated runtime variables.

### FIELD

The present invention relates to executing runtime programmable applications and more particularly to communications between apparatuses executing runtime programmable applications.

### BACKGROUND

Configuration of devices for different applications is difficult particularly, when the number of devices and the number of software and hardware configurations of the devices is high.

### SUMMARY OF THE INVENTION

The invention is defined by the features of the independent claims. Some specific embodiments are defined in the dependent claims.

According to a first aspect of the present invention, there is provided a system comprising a first apparatus configured to execute a first runtime programmable application, and a second apparatus configured to execute a second runtime programmable application, wherein the first runtime programmable application program comprises one or more references to variables of the second apparatus, wherein the first apparatus and the second apparatus are configured to communicate one or more variables defined by the references over a network connection and to set at least one of a variable of the first apparatus and a variable of the second apparatus on the basis of communicated runtime variables.

According to a second aspect of the present invention, there is provided an apparatus configured to execute a first runtime programmable application, and configured to communicate with another apparatus configured to execute a second runtime programmable application, wherein the first runtime programmable application program comprises one or more references to variables of said another apparatus, wherein the apparatus is configured to communicate one or more variables defined by the references over a network connection and to set at least one of a variable of the apparatus and a variable of said another apparatus on the basis of communicated runtime variables.

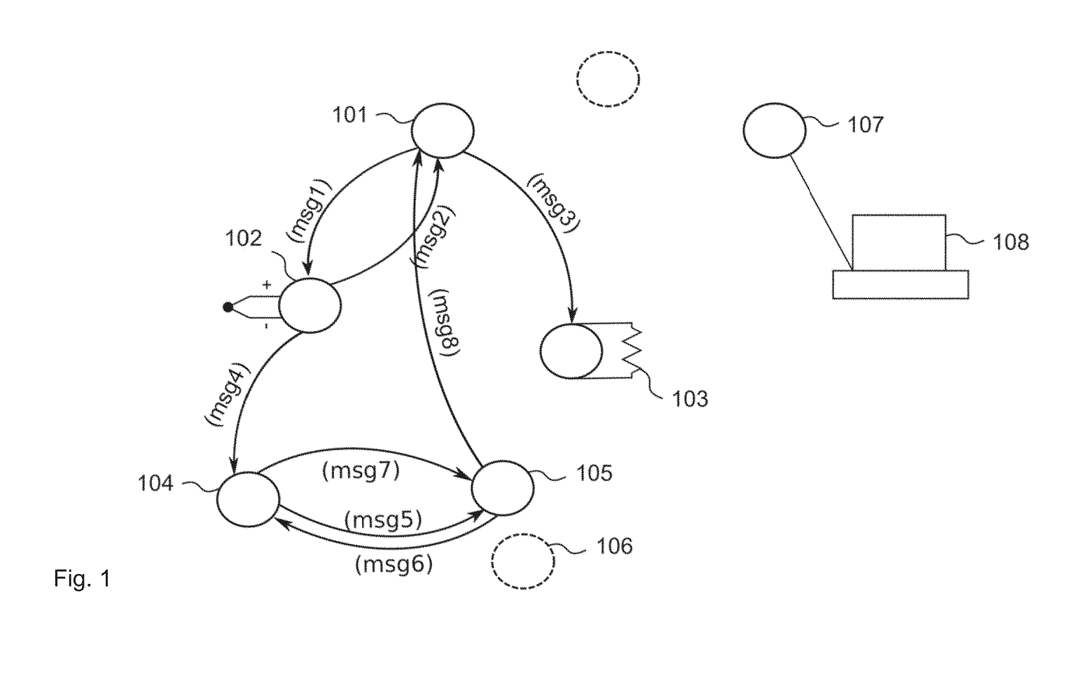

FIG. 1 illustrate an example of system in accordance with at least some embodiments;

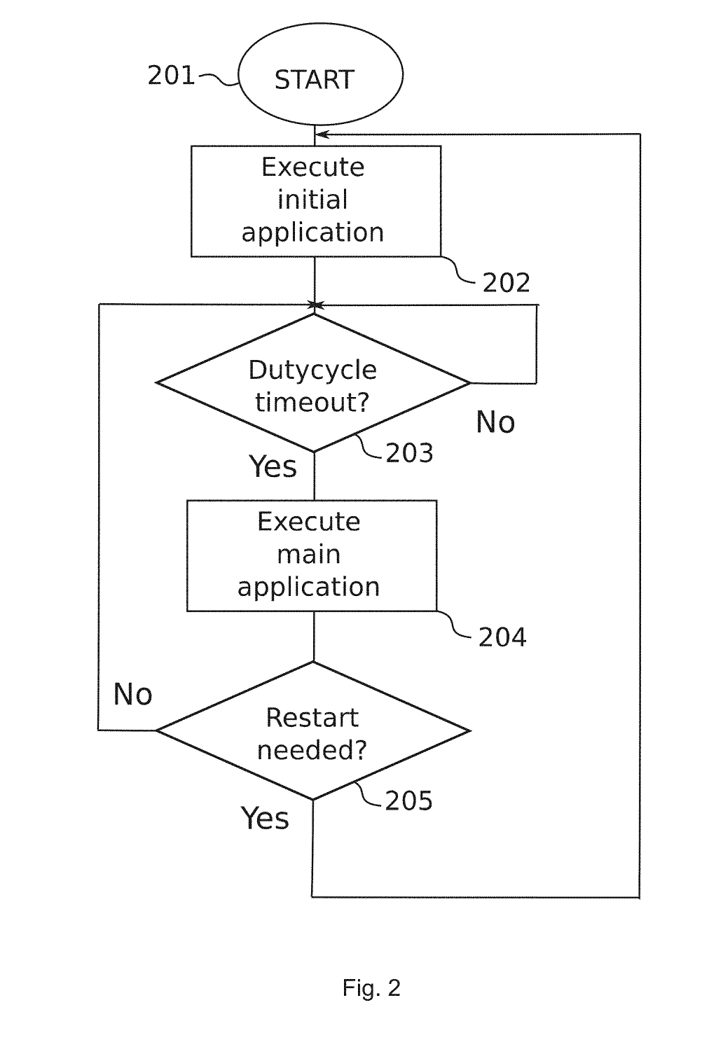

FIG. 2 illustrate a method in accordance with at least some embodiments; and

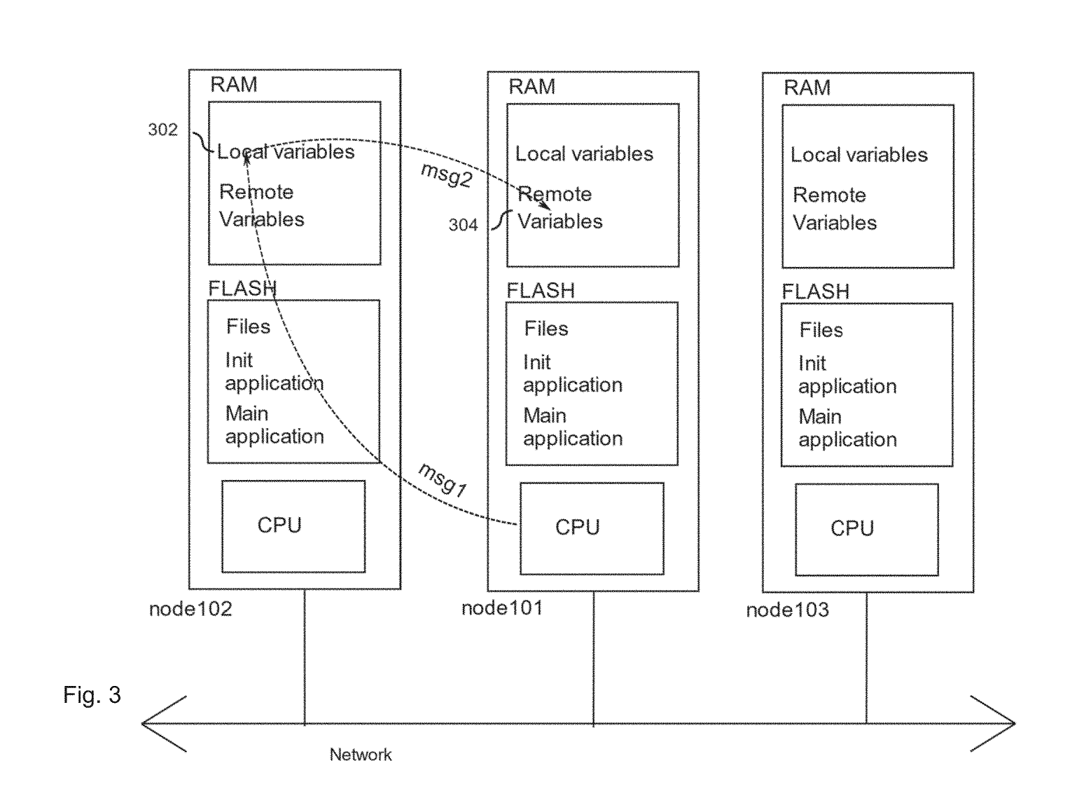

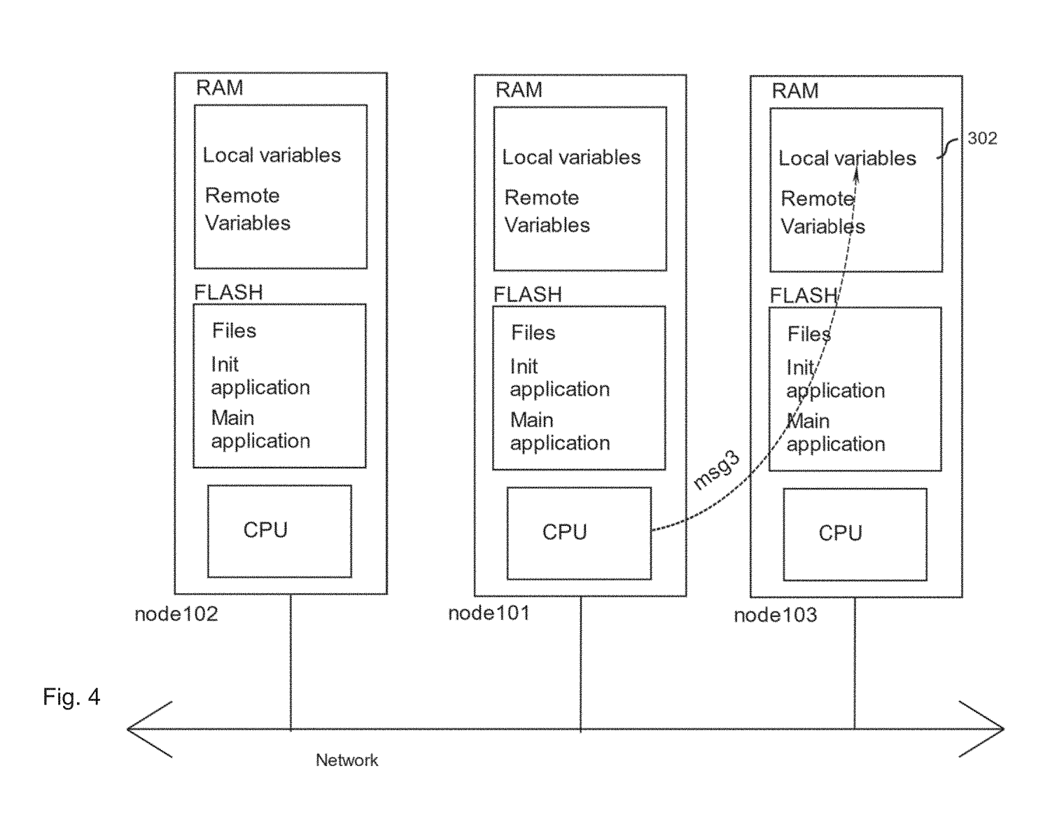

FIGS. 3 and 4 illustrate communications of variables between nodes in accordance with at least some embodiments.

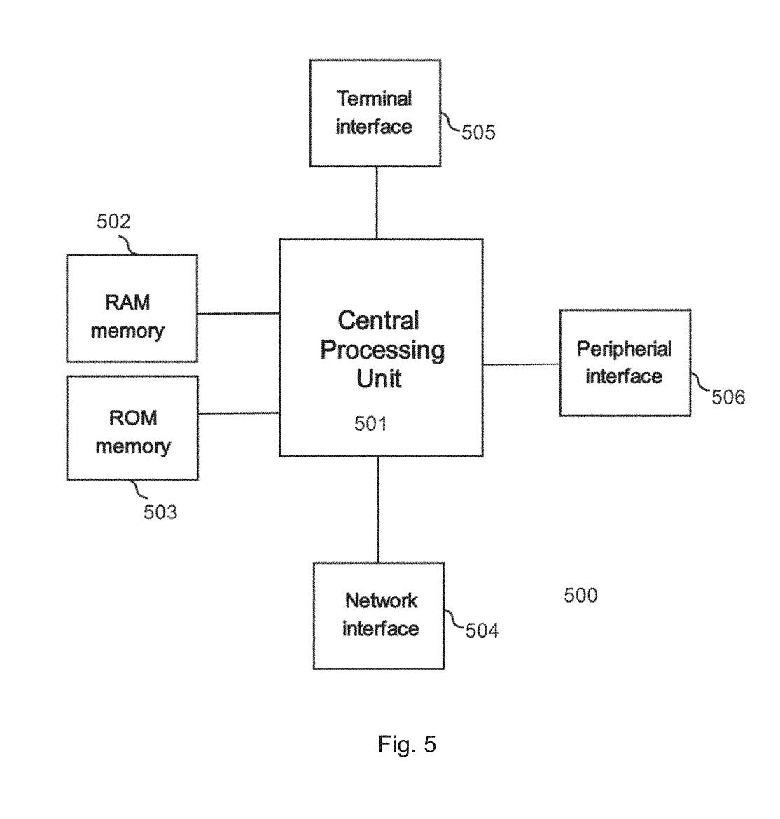

FIG. 5 illustrates an apparatus in accordance with at least some embodiments.

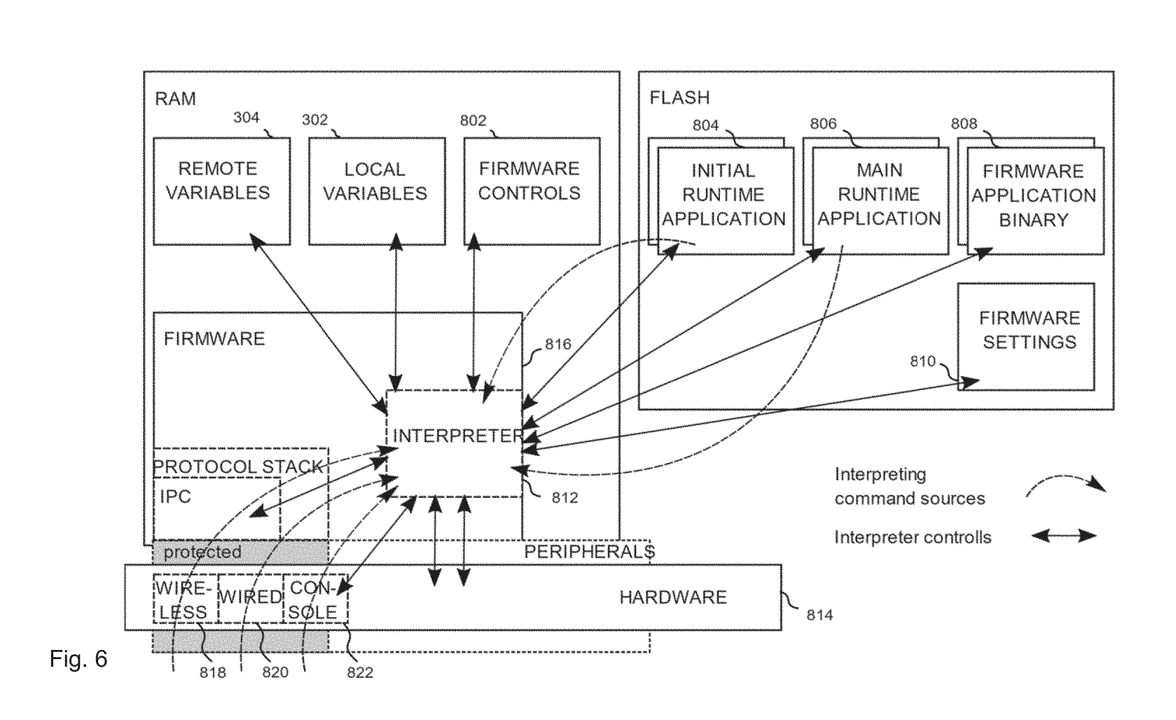

FIG. 6 illustrates intrepreter interaction with various system parts in accordance with at least some embodiments.

### EMBODIMENTS

An application program may refer to a runtime programmable application. A runtime programmable application may be capable of running or executing statement programming type of coding. The application program may comprise program instructions that may be executable by an interpreter for direct execution of the program instructions without compiling the program instructions into machine language. Program instructions may be programmed into the application program by statement programming. The program instructions may comprise one or more references to variables of apparatus executing the application program or to one or more apparatus connected to the apparatus executing the application. Accordingly, an application program executed on one apparatus may be capable of programming an application program residing in another apparatus to be executed in said another apparatus.

For running a runtime programmable application the system shall have a firmware or pure hardware support (later referred firmware). The firmware may take care of interpreting of runtime commands and statements, inter node communication, enable local variables setting and reading, enable remote variable setting and reading, enable (re)programming of runtime application programs, enable execution of runtime applications, may enable peripheral control interface to allow runtime program to configure and utilize available system peripherals and may protect crucial peripherals for inter node communication and for firmware operation. The firmware may offer methods for firmware reprogramming by programming tool or even by a runtime program application.

FIG. 1 illustrates an example of a system in accordance with at least some embodiments. The system comprises nodes 101, 102, 103, 104, 105, 106, 107 that may be configured to communicate over one or more communications channels. A communications channel may be a wireless communications channel or a wired communications channel. The communications channel provides that data transmitted by one node on the communications channel may be received by another node on the communications channel. In this way the nodes may be connected for communications of data. Communications of data between nodes may comprise communications of messages (msg1, msg2, msg3, msg4, msg5, msg6, msg7, msg8) that carry data between the nodes. Examples of the data comprise commands, statement programming type of code, readings, writings of data. The readings and writings may be included in the commands or statement programming type of code. A single message may include a payload of one or more units of data, for example one or more statements. The statements may comprise indexing such that a receiving node may detect missing and/or disordered statements and perform retransmission requests, compromise missing statement and/or re-ordering of the statements.

The nodes connected for data communications may form a communications network, where data may be routed from a sending/originating node to a destination node via one or more intermediary nodes.

A node 101, 102, 103, 104, 105, 106, 107 may be configured to execute one or more runtime programmable applications. A runtime programmable application program may comprise one or more references to variables of another node. Nodes connected by a network connection may execute runtime programmable applications and variables defined by the references may be communicated over a network connection between nodes. One or more variables of the nodes may be set on the basis of communicated runtime variables.

In an embodiment, the system may comprise a terminal device 108 for managing the system. The terminal device may be configured to establish a terminal connection to at least one of the nodes 107 of the system. The terminal connection provides that applications of the node connected to the terminal device may be programmed by the terminal device. The node connected to the terminal device may be configured to cause programming of one or more other nodes by the terminal device over connections between the nodes. In this way applications executed by the nodes may be managed by the terminal device and all the nodes in the system do not necessarily have to be directly connected to the terminal device.

In an example the terminal device may be a personal computer, a smart phone or tablet computer running a suitable operating system with terminal emulator application. The terminal device may be connect to the node, for example node 107, by a wired connection. The terminal device may be logged in to the node by providing user credentials to the node over the wired connection. After the terminal device has been logged in a file containing a main application program may be uploaded to the node, for example by a command “file upload main1”. After the main application program has been uploaded one or more statements may be executed. Examples of the statements for logging in to the node, uploading the main application program and programming the node may comprise, with annotations between “/*” “*/” signs:

>login node107 /*terminal device logging in to local node 107*/
node107>rlogin node101 /*terminal device logging to remote node 101*/
node101>file upload main1 /*Starting main1 application uploading*/
int0=node102 int0; /*1st statement line of main1 application*/
node104 int0=int0; /*2nd statement line of main1 application*/
eof /*end of file line of main1 application*/
node101>file activate main1 /*the main application is activated and the
execution of the main application is started */
node101>logout /*terminal device logging out*/
>

FIG. 2 illustrates a method in accordance with at least some embodiments of the present invention. The method may be carried out by an apparatus configured to execute a first runtime programmable application, and configured to communicate with a second apparatus configured to execute a second runtime programmable application. The apparatuses may be connected by a communications channel for data communications. The communications channel may be a communications channel in a communications network, for example a mesh network.

The method may start 201, when the apparatus is switched ON and capable of executing applications.

Phase 202 may comprise executing an initial application. The initial application program may be configured to perform at least one of setting up one or more initial variable values of the apparatus and setting up one or more existing peripherals of the apparatus. The initial application program may be e.g. an initialization file, a startup batch file or a startup script, which is read during or after boot/startup. The initial application program may also be executed during or after a reboot/restart. A reboot/restart may be needed for execution of a new main application program in phase 204. The initial application program and the main application program may be parts of the same application.

Phase 203 may comprise checking a duty cycle of the apparatus. The method may remain in phase 203 until a duty cycle timeout has elapsed. A duty cycle may refer to a time period comprising an execution time of an application program by an apparatus and a resting time immediately after or immediately preceding the execution time. Application duty cycle defines frequency of executing a main application program in phase 204. A duty cycle timeout defines a checkup moment when an application program resting period is passed. The resting period may be a set up time period or system default time period. The resting period may have a fixed length or a variable length. On the background may be other software or system processing activities like message delivery of the network. However, from a main application point of view, the resting period is a time period, where a node hosting the main application is in a low power mode of operation until the timeout has elapsed.

If the duty cycle timeout has elapsed, the method may proceed to phase 204, where a main application program is executed. The main application program may be an infinite loop which is ran every application duty cycle to perform the active application, until reboot or restart 205 is needed. The active application may be the main application program that may be activated for execution, at startup of the apparatus. Initially the main application program may be empty and programmed into use whenever is needed to via a terminal console connection from control location by user, central control or even by other node applications on runtime. A programming tool may be connected wirelessly or via wired connection to an apparatus hosting the main application program such that the main application program may be (re)programmed. The connection may be a direct connection without intermediary nodes between the programming tool and the apparatus hosting the main application. On the other hand the connection may be a remote connection, where the remote application tool and the apparatus hosting the main application are connected over a network. The programming tool may be the terminal device 108 or the programming tool may be hosted by the terminal device. The programming tool may be in just a set of commands for writing runtime program statements or more sophisticated tool.

The method may proceed from phase 204 to check the duty cycle in phase 203. The main application program may cause execution of a sequence of instructions and the method may proceed to phase 203 after the last instruction has been reached.

In an embodiment the method may comprise checking in phase 205 a need for restart of the apparatus after execution of the main application. If a need for restart id determined, the method may proceed to the beginning and phase 202 may be executed.

FIGS. 3 and 4 illustrate communications of variables over a network connection in accordance with at least some embodiments. The communications is explained with reference to the nodes 101, 102 and 103 of FIG. 1. However, it should be appreciated that the communications may be applied also to other variables and nodes in the system of FIG. 1. The nodes 101, 102 and 103 may have local variables 302 and remote variables 304 in runtime programmable applications that provide setting one or more variables in one node by references to variables of one or more other nodes. A local variable may refer to a variable of the node, where the variable comprises data obtained from a peripheral device. A remote variable may refer to a variable of the node, where the variable comprises data obtained from a data source connected over a communications network. Accordingly, data stored in the remote variable may be obtained from another node over the communications network.

The local variables 302 and the remote variables 304 may be stored to a runtime memory, for example a Random Access Memory (RAM). In this way access to the variables is fast. An initial application program and a main application program may be stored to a flash memory. Additionally, the flash memory may store data, for example files. The data may comprise for example data obtained by peripheral devices such as sensors. The flash provides that the applications and data may be preserved even if the node was switched OFF or the node enters a low power mode of operation, where the contents of the runtime memory may be discarded. The nodes comprise a central processing unit (CPU) that is capable of executing the applications stored in the flash memory.

Examples of programming applications are explained in the following with reference to FIGS. 1 to 4. In the example, the nodes have empty main application programs, the nodes belong to the same communications network. The nodes are accessible to be programmed at runtime with a new or updated main application program and/or initial application program. The nodes may be started/restarted to execute an initial application program in accordance with phase 202. After the execution of the initial application program, the main application program may be executed in a continuous loop in accordance with phase 204. In the example, a main application program may be executed according to an application duty cycle. The application duty cycle may be for example 10 min in each node. Variables of the nodes may be communicated according to a network duty cycle. Accordingly, the network duty cycle defines a frequency for communications of data between nodes of the communications network. On the other hand the need for communications of the variables is determined according to the application duty cycle during which the application and statements therein is executed. The network duty cycle may be adapted on the basis of a likelihood of changes the variables and/or a need for updated variables. By adjusting the duty cycles (even on runtime) system response times and power consumption can be programmed. E.g. fast response times can be obtained when the network duty cycles are set to minimum in all nodes of the communications network, but the network duty cycles may set to higher values, when longer response times are acceptable, whereby energy saving may be performed in an energy saving state.

Node 102 may be connected to a peripheral device. In this example, the peripheral device is a temperature sensor and the node 102 will be referred to as a temperature sensor node, however, it should be appreciated that also other sensors or devices that are capable of generating data may be used. The temperature sensor node may be configured with a sensor for measuring temperature. The sensor may be for example an analog temperature sensor, whereby the temperature sensor node may have an analogue to digital converter connected to the temperature sensor. An example of the main application program for the temperature sensor may comprise the following instructions with annotations between “/*” “*/” signs:
int0=a0x0200; /*read analog to digital converter value from address 0x0200 and store it to local integer variable int0*/
int1=int0*10; /*Modify data. Multiply integer int0 with 10 and store the result to local integer variable int1, whereby int1 is now usable final temperature value */

Node 103 may be a heater actuator node. The heater actuator node may have a digitally controlled heater. An example of the main application program for the temperature sensor may comprise the following instructions with annotations between “/*” “*/” signs:
a0x1020=int1; /*Integer int1 value is stored to the memory location 0x1020, which is the control bit of the heater (ON=1/OFF=0)*/
int0=node 102 int1; /* Reference to local variable of the temperature sensor node 102. Procedure to fetch int1 value from node 102 and set to remote variable node 102 int1 of node 101 via inter node messaging. The local variable int0 of the control node is set according to the variable of the temperature sensor node which is previously stored in remote variable node 102 int1 of the node 101. However, if node 101 does not have remote variable node 102 int1 may be used initial value or default value for statement operation or statement operation may be ignored. */
/* In the following, at least one operation is executed by the main application of the control node on the basis of the int0*/
L2=int0<16; /* int0 is compared to 16, if comparison is true jump to L2*/
L3=int0>21; /* int0 is compared to 21, if comparison is true jump to L3*/
L2; /*jump branch line label L2. Application program will not continue here if not jumped to label L2*/
node 103 int1=1; /* Reference to local variable of node 103. Send to node 103 int1=1 to switch heater ON.*/
L3; /*jump branch line label L3. Application program will not continue here if not jumped to label L3 */
node 103 int1=0; /* Reference to local variable of node 103. Send to node 103 int1=0 to switch heater OFF.*/

Once the main application program is executed 204 in the controller node 101, a messaging comprising messages msg1, msg2 and msg3 illustrated in FIG. 1 is started. Msg1 and msg2 provide pulling data or modified data by node 101 from a local variable 302 of the node 102 to a remote variable 304 of the node 101. Instruction “int0=node 102 int1” causes the main application program of the controller node to request node 102 every application duty cycle to tell a local integer int1 value of the node 102, by sending a message to node 102 msg1″node 101>node 102 “int1”.

After node 102 receives the msg1, it answers to the controller node 101 with msg2 ″node 102>node 101 “int1 9” where the value 9 is the latest value of the local variable int1 that stores a temperature value obtained by the sensor. It should be appreciated that if the controller node has not yet received the value from the temperature sensor node 102, a default or an initial value is used. In other implementations, it is feasible that operations such as extrapolation and/or averaging may be performed to the local variable int10.

Node 101 may push data or modified data to a local variable 302 of the node 103. For example, depending on the received value, the controller node 101 may control the heater actuator node to switch the heater ON or OFF. Accordingly, the controller node 101 may send e.g. msg3″node 101>node 103 “int1=1”, if the value was 9.

Node 104 may be a storage node. An example of the main application program for the storage node may comprise the following instructions with annotations between “/*” “*/” signs:
F0+int1=int0; /*store int0 value to file F0 location indexed by int1*/
int1=int1+1; /*increase integer int1 value used as location index*/

The main application program of the temperature sensor node may be added the following instructions to support the storage node functionality:
node 104 int0=int1; /* Reference to local variable of node 104. Sends the temperature value to storage node 104 for storing to local variable int0*/

When the temperature sensor node supports the storage node in accordance with the above applications, once the temperature sensor is restarted 205, the following messaging is performed:
Msg4 ″node 102>node 104 “int0 9”, where the value 9 represent the current measured temperature value.

Node 105 may be an analysis node. An example of the main application program for the analysis node may comprise the following instructions with annotations between “/*” “*/” signs:
node 104 int0=int1−144; /* Reference to local variable int0 of node 104. From integer int1 is reduced amount of samples stored in 1 day if 10 minutes application duty cycle has been used. Note that the local variable int1 of node 105 is kept up to date in current storing location index value by node 104 */
node 101 int0=int0; /* Reference to local variable int1 of node 101. Send to node 101 value of integer int0 that stores the temperature value one day ago.*/

The main application program of the storage node 104 may be added the following instructions to support the analysis node 105 functionality:
node 105 int1=int1; /* Reference to local variable int1 of node 105. Send to node 105 local variable int1 current index int1 of storing location. */
node 105 int0=F0+int0; /* Reference to local variable int0 of node 105. Get value from file F0 indexed with int0, (which will be updated by node 105,) and send the result to node 105 local integer variable int0. */

When the storage node supports the analysis node 105 in accordance with the above applications, once the storage node is restarted 205, the following messaging is performed:
Msg5 ″node 104>node 105 “int1 10600”, where the value 10600 represent the current sample location in storage node.
Msg7 ″node 104>node 105 “int0 16”, where the value 16 represents the temperature 24 h ago.

When the analysis node 105 is restarted 205, the following messaging is performed:
Msg6″node 105>node 104 “int0 10356”, /*where the value 10356 represent the one day earlier sample location in storage node.*/
Msg8″node 105>node 101 “int1 16”, /*where the value 16 represents the temperature 24 h ago. */

The analysis node provides analysis results that may be utilized in one or more other nodes of the communications network. To the main application program of the control node 101 may be changed to the following instructions to utilize the analysis results of the analysis node 105:
int0=node 102 int1; /* Reference to local variable of the temperature sensor node 102. Procedure to fetch int10 value from node 102 and set to remote variable node 102 int10 of node 101 via inter node messaging. The local variable int0 of the control node is set according to the variable of the temperature sensor node which is stored in remote variable node 102 int1 of the node 101. However, if node 101 does not have remote variable node 102 int1 may be used initial value or default value for statement operation or statement operation may be ignored.*/ int2=int0+int1;int2=int2/2; /*calculate average of the current and 24 h old result */
/* At least one operation is executed by the main application program of the control node on the basis of the int10*/
L2=int2<16; /*int2 is compared to 16, if comparison is true jump to L2*/
L3=int2>21; /*int2 is compared to 21, if comparison is true jump to L3*/
L2; /*Jump to branch line labeled L2. Application program will not continue here if not jumped to label L2*/
node 103 int1=1; /* Reference to local variable of node 103. Send to node 103 int1=1 to switch heater ON*/
L3; /*Jump to branch line labeled L3. Application program will not continue here if not jumped to label L3. */
node 103 int1=0; /* Reference to local variable of node 103. Send to node 103 int1=0 to switch heater OFF*/

It should be appreciated that one or more further analysis nodes 106 similar to the analysis node 105 could be added in the communications network, where each further analysis node could be caused by the main application program to provide different analysis of variables stored in the storage node 104. For example, whereas the analysis node 105 causes setting the local variable (node 101 int0) of the control node with a temperature that is a one day old, the further analysis node could be cause to set another remote variable of the control node for example with a temperature that is a week old temperature. In this way, more complex control could be achieved.

The apparatus, for example a node, 500 may comprise a central processing unit 501 and a memory 502, 503, and one or more communications interfaces. The central processing unit 501 may comprise one or more processing cores or processors. The communications interfaces may comprise a network interface 504 for communications with apparatuses belonging to the same communications network, a terminal interface 505 for communications with a terminal device, and a peripheral interface 506 for controlling of one or more peripheral devices and/or data transfer with one or more peripheral devices. The processor may comprise one or more processing cores. The processor may comprise at least one application-specific integrated circuit, ASIC. The processor may comprise at least one field-programmable gate array, FPGA. The processor may be means for performing method steps in the device. The method steps comprise instructions that are stored to the memory. The instructions may be part of application programs, whereby performing the method steps may cause execution of the application programs and/or, one or more instructions. Examples of the peripheral devices comprise sensors such as temperature sensors and devices that are capable of generating data, and actuators such as heater actuators.

The memory may comprise random-access memory and/or permanent memory. The memory may comprise at least one RAM chip. The memory may comprise solid-state, magnetic, optical and/or holographic memory, for example. The memory may be at least in part accessible to the processor 501. The memory may be at least in part comprised in the processor 501. The memory may store a computer program comprising computer instructions that the processor is configured to execute, to cause one or more functionalities described in the embodiments. The processor and the memory may be operatively connected to the processor for communications of data for execution of the computer program by the processor. The connection between the processor and the memory may be a data bus for example. When computer instructions configured to cause the processor to perform certain actions are stored in the memory, and the device in overall is configured to run under the direction of the processor using computer instructions from the memory, the processor and/or its at least one processing core may be considered to be configured to perform said certain actions. The memory may be at least in part comprised in the processor. The memory may be at least in part external to the device 500 but accessible to the device. Control parameters affecting operations in the device may be stored in one or more portions of the memory and used to control operation of the device.

The network interface, the terminal interface and the peripheral interface may provide communications channels for communications of data, packets and/or messages. Examples of the network interfaces, terminal interfaces and peripheral interfaces comprise cards and modules that may be configured to establish wired or wireless connections. Wireless connections for network and terminal interfaces may comprise IEEE 802.11 based Wireless Local Area Network (WLAN) connections, for example. The wired connections for network and terminal interfaces may comprise Ethernet, for example. Wireless connections for the peripheral interface may comprise Bluetooth, for example. Wired connections for peripheral interfaces comprise a computer data bus and RS-232 serial connection for example. The processor 501 may be operated to control at least some of the communications interfaces 504, 505, 506 by applying at least some of embodiments associated with execution of runtime programmable applications illustrated above in connection with FIG. 1.

FIG. 6 illustrates intrepreter interaction with various system parts in accordance with at least some embodiments. The interpreter interaction is described with reference to items of FIGS. 3 and 4. The interpreter interaction is illustrated in an example, where a node has firmware support for running runtime programmable applications. Accordingly, the node may comprise an interpreter 812 for handling at least one of a main runtime application program's 806 and an initial runtime application program's 804 statement interpreting to machine language understandable commands. The interpreter may be implemented in firmware or pure hardware for example. The same or separate interpreter may handle also node management commands. If same interpreter takes care of both then the runtime program statements, node management commands can both be included from same source to widen usage possibilities greatly. Then if the source input can be get from any source e.g. from initial runtime application program 804 ran on startup/reboot, main runtime application program 806 ran every application duty cycle, from remote management interface via wireless 818 or wired connection 820 by management tool or by another node (robot), or local management port 822 by connected management tool, the control possibilities, such as firmware controls 802, firmware settings 810, local variables 302, remote variables 304, are nearly limitless and enables full control of node reprogramming, even the reprogramming of firmware 816 and/or a firmware application library 808. Also control of node hardware and peripherals 814 may be possible be controlled via interpreter.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, i.e. a singular form, throughout this document does not exclude a plurality.

1. A system comprising a first apparatus configured to execute a first runtime programmable application program, and a second apparatus configured to execute a second runtime programmable application program, wherein the first runtime programmable application program comprises one or more references to variables of the second runtime programmable application program of the second apparatus, wherein the first apparatus and the second apparatus are configured to communicate one or more variables of the second runtime programmable application program defined by the references over a network connection and to set at least one of a variable of the first runtime programmable application program of the first apparatus and a variable of the second runtime programmable application program of the second apparatus on the basis of communicated runtime variables.

2. The system according to claim 1, wherein the second apparatus comprises a peripheral apparatus, and data or modified data from the peripheral apparatus is stored to the variable of the second apparatus, and wherein the first runtime programmable application program comprises a reference to the variable of the second apparatus storing the data or modified data from the peripheral apparatus, whereby the runtime variable of the first apparatus is set according to the variable of the second apparatus storing the data or modified data from the peripheral apparatus, and at least one operation is executed by the first runtime programmable application program on the basis of the set variable of the first apparatus.

3. The system according to claim 1, wherein the variables defined by the references are communicated according to a network duty cycle and the runtime programmable applications are executed according to application duty cycles.

4. The system according to claim 3, wherein the network duty cycle is adapted on the basis of a likelihood of changes the variables and/or a need for updated variables.

5. The system according to claim 1, wherein an initial application program configured to perform at least one of setting up one or more initial variable values and setting up one or more existing peripherals is executed before execution of a runtime programmable application.

6. The system according to claim 1, wherein data or modified data is pushed by the second apparatus to a local variable of the first apparatus.

7. The system according to claim 1, wherein data or modified data is pulled by the first apparatus from a local variable of the second apparatus to a remote variable of the first apparatus.

8. The system according to claim 1, wherein the apparatuses are connected by a mesh network.

9. An apparatus configured to execute a first runtime programmable application program, and configured to communicate with another apparatus configured to execute a second runtime programmable application program, wherein the first runtime programmable application program comprises one or more references to variables of the second runtime programmable application program of said another apparatus, and wherein the apparatus is configured to communicate one or more variables the second runtime programmable application program defined by the references over a network connection and to set at least one of a variable of the first runtime programmable application program of the apparatus and a variable of the second runtime programmable application program of said another apparatus on the basis of communicated runtime variables.
